(19) United States
(12) Patent Application Publication
(10) Pub. No.: US 2004/0205424 A1
(43) Pub. Date: Oct. 14, 2004

(54) Differential filter with high common mode rejection ratio

(75) Inventor: Michael C. Garrett, Wilmette, IL (US)

Correspondence Address: FITCH EVEN TABIN AND FLANNERY, 120 SOUTH LA SALLE STREET, SUITE 1600, CHICAGO, IL, 60603-3406, US

(73) Assignee: AJ Medical Devices, Inc.

(21) Appl. No.: 10/656,914

(22) Filed: Sep. 5, 2003

Related U.S. Application Data
(60) Provisional application No. 60/408,976, filed on Sep. 6, 2002.

(51) Int. Cl. G11B 5/00; G06K 5/04; G11B 20/20

(52) U.S. Cl. 714/700

(57) ABSTRACT

A differential amplifier (701) has an input for coupling to one or more signal sources (702). An offset error correction parameter input (704) is provided proximal to this input and serves to facilitate the reduction or elimination of undesired DC or low frequency offsets while further permitting a relatively large gain to be applied to the incoming signal without also amplifying considerable undesired DC/low frequency offset content.

### RELATED PATENT APPLICATIONS

This patent application claims the benefit of provisional patent application No. 60/408,976 as filed on Sep. 6, 2002 and entitled Differential Filter With High Common Mode Rejection Ratio.

### FIELD OF THE INVENTION

This invention relates generally to signal amplification and more particularly to offset compensation.

### BACKGROUND

Signal amplification comprises a well-established field of endeavor. In many instances, for example, a given signal will be amplified in order to facilitate subsequent processing (including but not limited to filtering, conversion to digital form, threshold comparison, and so forth). As a specific example, electrodes can be used to monitor the heart; the electrical signals provided by such electrodes tend to be relatively small and usually require amplification in order to effect useful subsequent analysis and processing.

Noise of various kinds often accompanies the use of signal amplification. Sometimes the amplification process itself introduces noise. Other times the noise is present in the original signal as introduced to the amplifier. When dealing with the latter situation, amplification of the signal will also typically result in amplification of the accompanying noise. In some instances this leads to an unacceptably noisy amplified signal. In other instances, amplification of the noise component (such as a direct current or low frequency component) can lead to saturation of the amplifier and resultant ineffective or otherwise compromised operation of the amplifier.

For example, heart-monitoring electrodes often comprise two or more electrodes that provide an electrical signal in correspondence to the muscle contraction activity of the heart. A typical human body, however, generates a variety of other electrical signals and corresponding fields that can and do contribute noise to such heart-related electrical signals as transported by the electrodes. To meet this need, common mode rejection techniques are often applied to remove or at least attenuate this noise contribution. It is also not uncommon for one of the electrodes to include a direct current or low frequency offset as also introduced by ionic potential creation at the electrode body interface. Such an offset is typically not common to both (or all) electrodes and hence will not be substantially reduced by common mode rejection techniques. A typical prior art response has been to first provide the signals from such electrodes to a low gain (such as a unity gain) differential amplifier to attenuate the common mode noise contribution, and then pass the resultant signal through a high pass filter that substantially removes the direct current/low frequency offset component. A high gain amplifier stage (having a gain of, for example, 100 to 500) then amplifies the resultant noise-free signal to a useful level and range.

Though usually effective, such an approach is not without issues at least under some operating conditions and circumstances. For example, the use of cascaded amplifier stages can lead to a parts count requirement that may be at odds with size or form factor limitations and/or power drain requirements.

### BRIEF DESCRIPTION OF THE DRAWINGS

The above needs are at least partially met through provision of the differential filter with high common mode rejection ratio method and apparatus described in the following detailed description, particularly when studied in conjunction with the drawings, wherein:

FIG. 1 comprises a conceptual schematic view in accordance with various embodiments of the invention;

FIG. 2 comprises a schematic view in accordance with an embodiment of the invention;

FIG. 3 comprises a schematic view in accordance with another embodiment of the invention;

FIG. 4A comprises a schematic view in accordance with yet another embodiment of the invention;

FIG. 4B comprises a more generalized view of the embodiment presented in FIG. 4A;

FIG. 5 comprises a schematic view in accordance with yet another embodiment of the invention;

FIG. 6 comprises a block diagram in accordance with yet another embodiment of the invention; and

FIG. 7 comprises a block diagram in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Pursuant to these various embodiments, a signal is provided to an input of a differential amplifier and a DC (and/or a low frequency) component of the signal is substantially removed proximal to that input. Depending upon the embodiment, this removal can occur external to the differential amplifier or internal thereto.

Pursuant to one embodiment, at least one signal as carried by at least two signal inputs that correspond to a bio-metric parameter (such as heart contraction data) is combined with an error correction parameter to provide a resultant error-corrected signal. The latter is then amplified to provide an amplified resultant error-corrected signal. Depending upon the embodiment, this error correction parameter can comprise a DC offset error correction parameter and/or a low frequency (such as a 1 Hz or less parameter) error correction parameter. When amplified, the level of gain can be considerable (ranging, for example, upwardly from a gain of 25).

Pursuant to a preferred approach, the error correction parameter is provided through processing of an earlier amplified resultant error-corrected signal. For example, an earlier amplified resultant error-corrected signal can be compared against a reference value (such as, in a preferred embodiment, a desired DC offset value to be maintained as a part of the amplified resultant error-corrected signal) to determine a particular error correction parameter. Pursuant to one embodiment, the reference value can comprise a substantially fixed value. Pursuant to another embodiment, the reference value can be dynamically determined as a function of one or more monitored conditions or parameters.

It is also possible to provide the error correction parameter by processing the earlier amplified resultant error-corrected signal in a frequency selected manner (such as, for example, a low frequency passage manner, a high frequency passage manner, or a narrow band frequency passage manner). It is also possible to combine the error correction signal with additional signals as may be carried by the signal inputs (for example, when three or more heart monitoring electrodes are utilized) to provide a plurality of resultant error-corrected signals.

One embodiment provides a differential amplifier with a high pass or band pass frequency response that can be implemented in discrete or integrated form.

So configured, an amplifier can provide both common mode rejection of common mode noise while also providing DC/low frequency offset compensation and/or maintenance while only utilizing a single amplification stage. This in turn permits a less complicated and smaller amplification stage that will also typically consume a reduced amount of power as compared to at least some prior art approaches.

For purposes of illustration, a specific application described herein comprises biomedical signal processing of epicardial electrocardiograph (ECG) data. (Those skilled in the art, however, will understand that there are many other fields that could benefit from these teaching including but not limited to seismic signal amplification, sub-harmonic physical signal measurement and audio processing.) In order to effectively analyze ECG signals it is preferred to acquire signals in the frequency range of 0.05 Hz to 150 Hz. This band of frequencies is considered in the art to comprise the diagnostic frequency response. Using this range of frequencies, processing equipment can use various algorithms to asses the condition of the heart and to alert health care providers of the current condition or an aberrant potentially life threatening condition.

Subsets of the diagnostic frequency range can be used to detect large scale features of the ECG waveform such as the overall ventricular rate and gross beat morphology such as the overall ventricular rate and gross beat morphology such as tachycardia or fibrillation. These subsets include 0.30 Hz-40 Hz for limited diagnostic processing, 0.5 Hz to 40 Hz for general monitoring, and 2 Hz to 20 Hz for two lead or interference-prone monitoring from lower quality electrodes. Many applications must include all of these response options in order to fulfill the mission profile of the equipment being deployed. Monitoring system applications can span the range of small-integrated implantable monitors to emergency service monitoring in extreme locations.

The environment of use can vary widely as described above. In addition to the local physical environment the electrical environment can vary to extremes. Many monitoring applications take place in areas that contain various sources of electrical and electromagnetic interference. The frequency range of this interference can range from well below 1 hertz to many thousands of Megahertz. The sources of this interference include slowly varying static electric fields from personnel or patient movement, interference from power sources such as common line voltage, or alternate power sources provided in ambulances or aircraft as well as electromagnetic interference from radio transmission devices. In most cases these interfering sources are classified as common mode interfering sources affecting the patient as a whole. (The whole monitoring system varies with the patient, who varies with the interfering source.) The environment can also include interference sources that create interference of a differential nature. Examples of such sources include stimulus pulses applied by the instrumentation itself (such as pacing pulses or defibrillation pulses in the case of ECG application or impulse injection in the case of seismic detection and imaging). Large differential offsets may also present themselves due to a patient connection mechanism such as silver-silver chloride electrodes. Out-of-band signals below the cutoff frequency of interest that can manifest themselves as a DC offset voltage of the source or very low wandering of the sensor and or amplifiers are also common in many fields of interest.

These embodiments can facilitate maximizing the signal handling capability of alternating current (AC) signals of interest while rejecting low frequency and stimulus content.

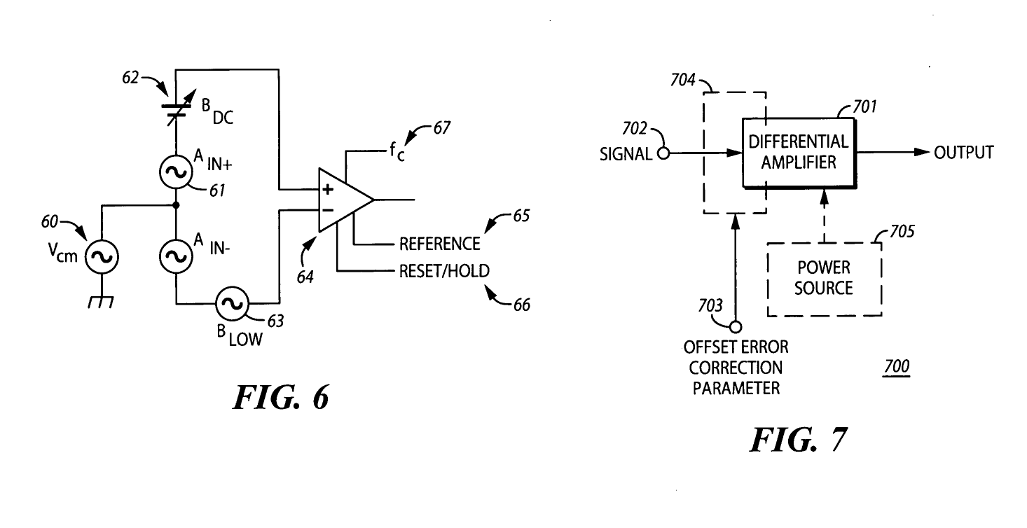

With initial reference to FIG. 7, an apparatus 700 according to a preferred embodiment can comprise a differential amplifier 701 having an input that couples to receive a signal source 702 (such as, but not limited to, a bio-metric signal source such as a bio-metric monitoring device). It will be understood by those skilled in the art that this input can in fact comprise a plurality of signal inputs depending upon the particular sensing architecture. The apparatus 700 includes an input 704 that receives an offset error correction parameter 703. In a preferred approach, this input 704 is disposed proximal to the input of the differential amplifier to thereby avoid amplification of undesired offsets. As will be shown below in more detail, this input 704 can be disposed proximal to the differential amplifier 701 input either external to the differential amplifier 701 or effectively internal thereto as may best fit the needs of a given application.

So configured, the differential amplifier 701 includes the capability of using the error correction parameter to provide an output comprising a resultant error-corrected signal (and preferably an output signal that is also amplified by a gain and wherein common mode noise has been substantially deleted therefrom). As will also be shown below in more detail, this configuration can also be utilized to ensure that the differential amplifier 701 output signal includes a predetermined offset (to lift, for example, the resultant signal to a desired position within a given operating range of values).

Typically, such an apparatus 700 will also include a power source 705 such as, for example, a battery. In a preferred approach this power source will comprise a 1.5 volt battery but other possibilities of course exist and are compatible with these embodiments.

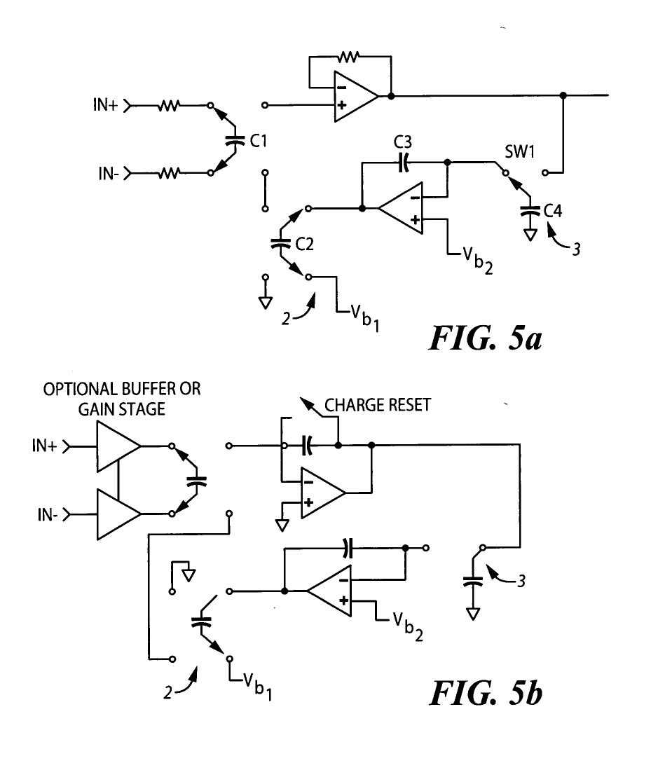

FIG. 6 depicts a conceptual diagram of a preferred embodiment. An input signal composed of undesired common mode 1, DC offset 2, undesired low frequency signals 10, and a desired differential AC signal is presented to differential high pass filter 5. As noted above, the signal of interest must preferably be separated from the undesired signals. The signal present at the output of the differential high pass filter may also require an additional offset voltage 6 and also may require resetting to a known initial condition or holding for noise rejection and/or sampling purposes 7. It is also optionally possible that the high pass and low pass characteristic in some applications may require changing (in response, for example, to a control signal 8).

This embodiment achieves such results by feeding back an error signal to the front end amplification stages. In a preferred application, this error signal comes from a gated integrator inserted into the feedback loop. Inserting the integrator into this position causes the system to contain a zero located at 0 Hz and a pole location that can be selectively moved by changing a gain factor as corresponds to the integrator or system. In order to hold a present state of the integrator in the presence of noise, a switch can be inserted prior to the integrator to substantially eliminate an introduction of interference into the loop.

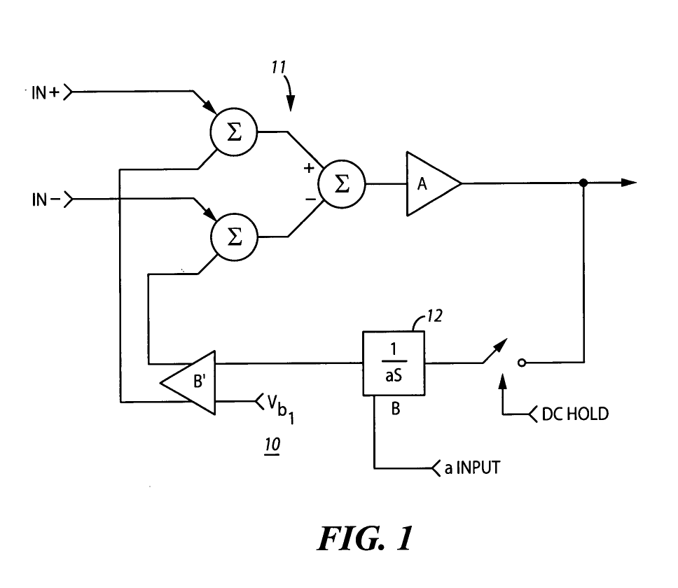

FIG. 1 shows a block diagram of the system with the feedback having the same units as the input, i.e. voltage or current. FIG. 1 further depicts the general concept of providing differential feedback to an input stage to alter the DC and/or low frequency state of the system. The loop feedback could be any suitable transfer function to accommodate the needs of a particular application.

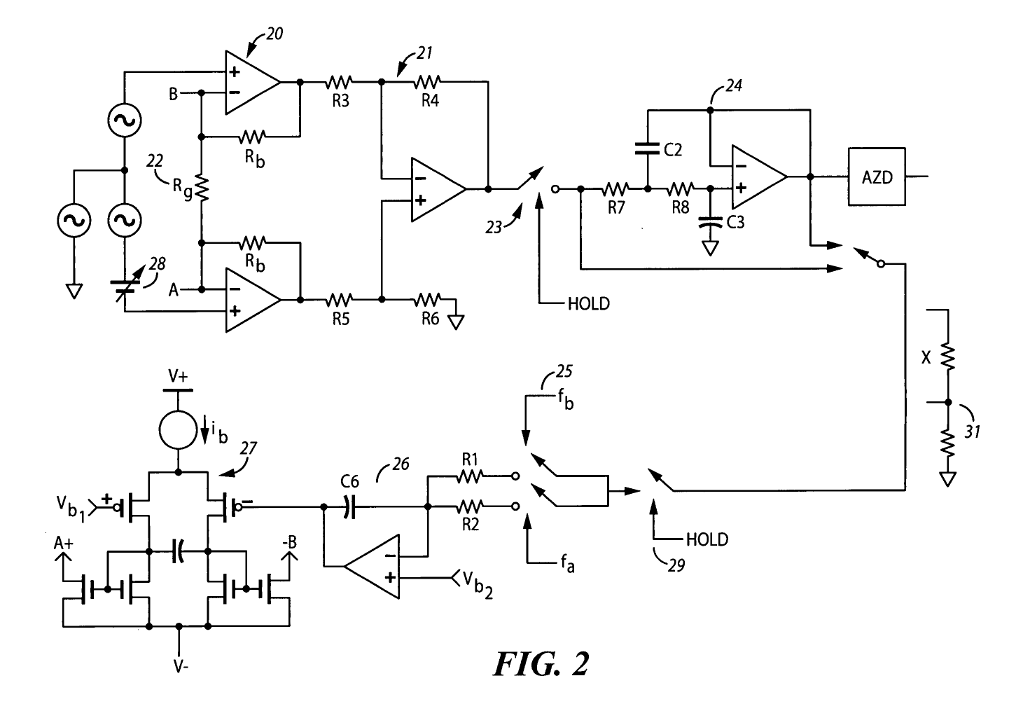

FIG. 2 shows an embodiment comprising a practical continuous time implementation of the circuit suitable for discrete design. A high impedance input differential gain stage 1 amplifies the input signal along with an error feedback parameter. This differential signal is converted to a single ended signal by a downstream module 2. In this implementation, the gain is largely determined by resistor Rg 8. This stage has a gain of 2*Rb/Rg for differential signals and a gain of 1 for common mode signals. This allows highly effective common mode performance to be achieved.

A second stage 2 differences the output of the first stage to cancel common mode signals and convert the differential input to a single ended output. The output of this second stage 2 is fed through a hold switch 3 to an optional low pass filter 4. The advantage of including this filter in the loop is that the loop will cancel offset voltages of the filter. This filter can be included to create a band pass response to the system as well as serving as an anti-aliasing filter.

The output of stage 2 or 4 is then fed through a hold switch 3 through one of a number of possible resistors 5 to introduce various resistor dependant currents into the integrator 6. By selecting various resistors at this point, differing high pass cutoff frequencies can be achieved. The output of the integrator 6 is converted to a differential current by a transconductance amplifier 7. This amplifier will preferably present high drain impedances to connection points A and B in order to maintain high common mode rejection. It will be appreciated that the error current introduced across resistor Rg effectively cancels DC or low frequency signals present at IN+ and IN− represented by voltage source 9.

Vb1 can be set to a voltage that represents the best output voltage of the integrator to attain an optimal error signal. One example would be to keep the operational transconductance amplifier 7 in the saturation region. The overall DC offset present in the output signal is set by Vb2 making this voltage a suitable point to introduce an offset in a digital sampled system using a single ended supply. Input impedance of this implementation is preferably kept very high due to the input stage construction. It will of course be appreciated that this circuit could be constructed in single ended or differential form.

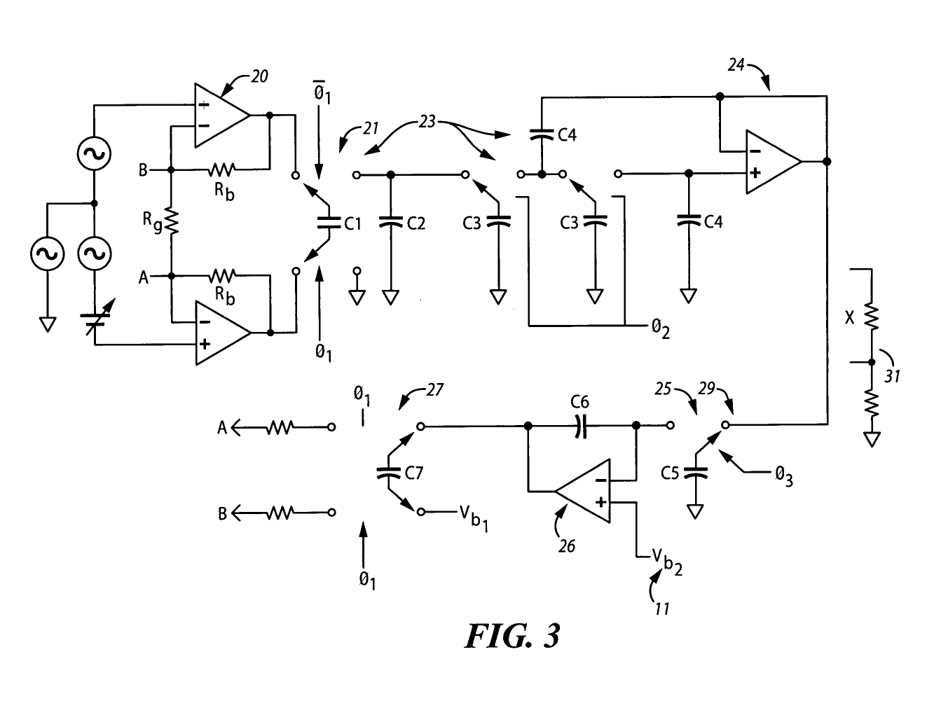

FIG. 3 shows a circuit similar to that depicted in FIG. 2 though implemented as a switched capacitor circuit suitable for discrete implementation. (Such a circuit could also, of course, be implemented directly in silicon). This circuit performs in substantially the same way as the circuit depicted in FIG. 2. This circuit allows clock control of both high pass and low pass cutoff frequencies by changing the clock rate of clocks o1, o2, and o3. These clocks can also be stopped to reject transient or stimulus pulses. When the clocks are stopped in the correct phase, the output transient will not appear in the output nor charge capacitors C1, C3, C4, C5, or C6 and thereby allowing substantially complete rejection of transients.

Resetting of the high pass filter can be achieved by speeding up the clock rate of clock o3 to move the pole away from the imaginary axis. This circuit can be implemented to achieve a very low supply current/performance ratio.

In FIGS. 2 and 3, an attenuator 12 can be included to reduce the overall feedback gain to thereby allow potentially more practical values of integrating components. For example, the effective resistance of switch 3,5 of FIG. 3 can be set very high (higher than is practical in a silicon implementation) allowing more practical implementation.

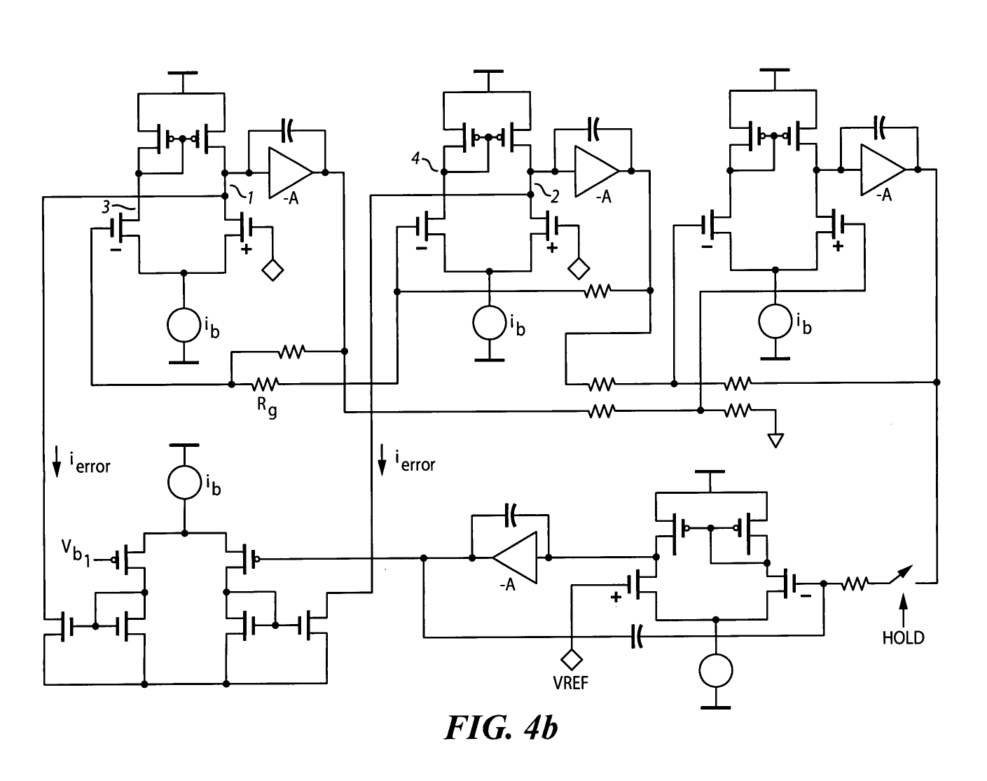

FIG. 5A presents a relatively simple embodiment. Here the input signal is differentiated directly via a charge present on capacitor C1. As the input is being sampled, the feedback required to drive the error to zero is sampled by capacitor C2. When the switches are toggled, the error voltage is added to the input to zero the error voltage. The high pass cutoff frequency as well as transient blanking can be controlled with switch 1.

FIG. 5B show a similar circuit utilizing a charge amplifier. The first stage has a negative gain, which is accounted for by introducing a phase reversal in the switches 2. Transient blanking can be controlled by switch 3 as well as the cutoff frequency.

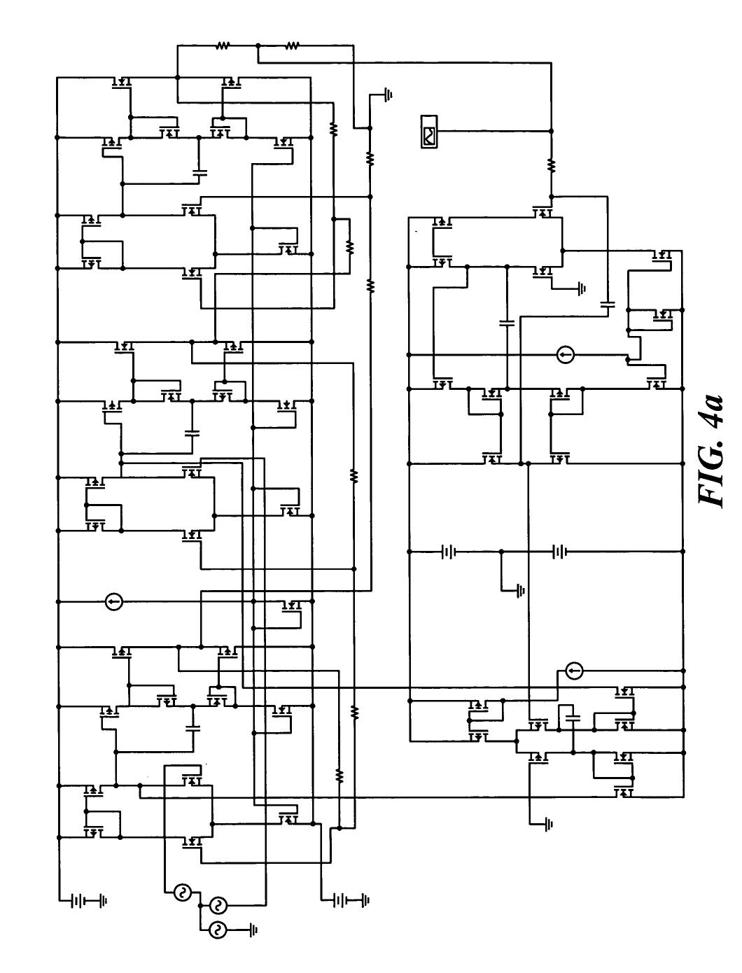

In both discrete and integrated designs, various methods can be used to achieve the desired results. FIGS. 2 and 3 depict embodiments realized in discrete components. FIG. 4 presents a MOSFET embodiment. In an integrated form as shown in FIGS. 4a and 4b, a differential operational transconductance amplifier feeds back error currents to the input stages of a differential amplifier. The current can be fed back to any stage suitable for error differencing. In FIG. 4b, the error current is fed back to points 1 and 2 causing a balancing effect in the early stages. With a phase reversal as indicated on the drawing the current can be fed back to points 3 and 4. The differences between these two are subtle and relate to overall frequency stability and bias point considerations.

The high pass cutoff frequency is largely determined by the zero and pole created by inserting an integrator in the feedback loop. As desired, more than one pole location can be created using appropriate means. The switched capacitor example exemplifies this depending on the ratio and sizes of the various sampling capacitors in the feedback loop combined with the sample frequency of the sampling clock.

Pursuant to all of these embodiments, a differential amplifier that provides common mode noise cancellation is further able to apply considerable gain to an initially applied signal notwithstanding a presence of an undesirable DC and/or low frequency offset. These embodiments further permit a desired amount of DC offset to be maintained with respect to the amplified signal.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method of removing offsets to a signal comprising:
providing at least two signal inputs that correspond to a bio-metric parameter;
providing an error correction parameter;
combining at least one signal carried by the at least two signal inputs with the error correction parameter to provide a resultant error-corrected signal;
amplifying the resultant error-corrected signal to provide an amplified resultant error-corrected signal.

2. The method of claim 1 wherein providing an error correction parameter comprises providing a DC offset error correction parameter.

3. The method of claim 1 wherein providing an error correction parameter comprises providing a low frequency offset error correction parameter.

4. The method of claim 3 wherein providing a low frequency offset error correction parameter comprises providing a low frequency offset error correction parameter as corresponds to a frequency of less than 1 Hertz.

5. The method of claim 1 wherein amplifying the resultant error-corrected signal comprises amplifying the resultant error-corrected signal by at least a gain of 50.

6. The method of claim 1 wherein providing an error correction parameter comprises processing an earlier amplified resultant error-corrected signal.

7. The method of claim 6 wherein processing an earlier amplified resultant error-corrected signal comprises comparing the earlier amplified resultant error-corrected signal to a reference value.

8. The method of claim 7 wherein the reference value comprises a substantially fixed value.

9. The method of claim 8 wherein the reference value comprises a desired offset value to be maintained as a part of the amplified resultant error-corrected signal.

10. The method of claim 6 wherein processing an earlier amplified resultant error-corrected signal comprises processing an earlier amplified resultant error-corrected signal in a frequency selected manner.

11. The method of claim 10 wherein the frequency selected manner comprises at least one of:
low frequency passage;
high frequency passage;
narrow band frequency passage.

12. The method of claim 1 and further comprising combining a second signal carried by the at least two signal inputs with the error correction parameter to provide a second resultant error-corrected signal.

13. A bio-metric monitoring device amplifier comprising:
a power source;
a plurality of signal inputs;
an initial amplifier that operably couples to the power source and that receives a bio-metric signal as carried by the plurality of signal inputs, wherein the initial amplifier has a gain of at least 25.

14. The bio-metric monitoring device amplifier of claim 13 wherein the power source comprises a 1.5 volt battery.

15. The bio-metric monitoring device amplifier of claim 13 and further comprising an error correction parameter and wherein the initial amplifier is responsive to the error correction parameter.

16. The bio-metric monitoring device amplifier of claim 13 and further comprising an error correction parameter and a combiner that operably couples to receive the error correction parameter and at least one of the plurality of signal inputs.

17. The bio-metric monitoring device amplifier of claim 16 wherein the combiner provides an error-corrected output to the initial amplifier.

18. The bio-metric monitoring device amplifier of claim 13 and further comprising means for processing a resultant amplified signal from the initial amplifier to provide an error correction parameter.

19. The bio-metric monitoring device amplifier of claim 18 wherein the error correction parameter comprises at least one of:
a DC offset correction parameter;
a low frequency offset correction parameter.

20. A method comprising:
providing a differential amplifier having an input;
providing a signal;
substantially removing at least a DC component of the signal proximal to the input of the differential amplifier.

21. The method of claim 20 wherein substantially removing at least a DC component of the signal proximal to the input of the differential amplifier comprises substantially removing at least a DC component of the signal prior to provision to the input of the differential amplifier.

22. The method of claim 20 wherein substantially removing at least a DC component of the signal proximal to the input of the differential amplifier comprises substantially removing at least a DC component of the signal within the differential amplifier.

23. An apparatus comprising:
a differential amplifier having an input to facilitate coupling to a signal source;
an offset error correction parameter input disposed proximal to the input of the differential amplifier to avoid amplification of undesired offsets.

24. The apparatus of claim 23 wherein the signal source comprises a bio-metric signal source.

25. The apparatus of claim 23 and further comprising error correction means for using the error correction parameter to provide a resultant error-corrected signal.

26. The apparatus of claim 25 wherein the differential amplifier has an output that provides the resultant error-corrected signal as amplified by a gain.

27. The apparatus of claim 26 wherein the differential amplifier has an output that provides the resultant error-corrected signal as amplified by the gain and having a predetermined offset.

28. The apparatus of claim 27 wherein the predetermined offset comprises at least one of:
a DC offset;
a low frequency offset.

29. The apparatus of claim 27 wherein the predetermined offset comprises a non-zero predetermined offset.
